(19) United States
(12) Patent Application Publication
(10) Pub. No.: US 2015/0270687 A1
(43) Pub. Date: Sep. 24, 2015

(54) SPARK PLUG AND IGNITION SYSTEM

(71) Applicant: NGK Spark Plug Co., LTD., Nagoya (JP)

(72) Inventors: Takuya KAWADE, Hashima (JP); Naofumi YAMAMURA, Nagoya (JP)

(73) Assignee: NGK Spark Plug Co., LTD., Nagoya (JP)

(21) Appl. No.: 14/662,824

(22) Filed: Mar. 19, 2015

(30) Foreign Application Priority Data
Mar. 22, 2014 (JP) 2014-059351

(51) Int. Cl. H01T 13/20; H01T 15/00

(52) U.S. Cl. CPC H01T 13/20; H01T 15/00

(57) ABSTRACT

A spark plug has a center electrode containing a shaft portion, a tip portion joined to a forward end portion of the shaft portion, and a joint portion joining the shaft portion and the tip portion together. In the spark plug, the distance between the surface of the center electrode and an inner edge of the insulator is 0.3 mm or greater. The inner edge is a forward-end-side edge of an inner circumferential surface of a small diameter portion of the insulator, the small diameter portion being a part of a portion of the insulator for accommodating the tip portion and having the smallest inner diameter.

This application claims priority from Japanese Patent Application No. 2014-059351 filed with the Japan Patent Office on Mar. 22, 2014, the entire content of which is hereby incorporated by reference.

### FIELD OF THE INVENTION

The present invention relates to a spark plug and an ignition system.

### BACKGROUND OF THE INVENTION

Conventionally, an ignition system has been used for igniting, for example, an air-fuel mixture within a combustion chamber of an internal combustion engine. For example, a system including a spark plug and a power supply for supplying electrical energy to the spark plug is used as an ignition system. The spark plug includes, for example, a center electrode extending in an axial direction thereof, an insulator disposed around the center electrode, a tubular metallic shell disposed around the insulator, and a ground electrode having a proximal end portion joined to a forward end portion of the metallic shell. A gap is formed between a distal end portion of the ground electrode and a forward end portion of the center electrode. When the power supply supplies electrical energy to the gap, spark discharge is produced at the gap. The air-fuel mixture is ignited by the spark discharge.

### PRIOR ART DOCUMENT

### Patent Document

[Patent Document 1] WO 2013/073487 A1[Problem to be Solved by the Invention]

Incidentally, in recent years, various types of internal combustion engines (for example, lean burn engines, direction injection engines, etc.) have been developed in order to reduce fuel consumption. With the progress of the development of such internal combustion engines, further enhancement of the durability of spark plugs has been desired. However, enhancement of the durability of spark plugs has been difficult.

A main object of the present invention is to enhance the durability of spark plugs.

### SUMMARY OF THE INVENTION

### Means for Solving the Problem

The present invention has been accomplished so as to solve, at least partially, the above-described problem, and the present invention can be embodied in the following application examples.

### Application Example 1

A spark plug comprising:

a tubular insulator having an axial hole extending therethrough along an axial line;

a center electrode disposed at an end of the axial hole on a forward end side; and

a rod-shaped ground electrode forming a gap between the ground electrode and a portion of the center electrode on the forward end side, wherein

the center electrode includes a shaft portion, a tip portion joined to a forward end portion of the shaft portion, and a joint portion joining the shaft portion and the tip portion together;

an end of the joint portion on the forward end side is located on a rear end side in the direction of the axial line in relation to an inner edge of the insulator, which is a forward-end-side edge of an inner circumferential surface of a small diameter portion of the insulator, the small diameter portion being a part of an accommodation portion of the insulator for accommodating the tip portion, which part has the smallest inner diameter in the accommodation portion; and

a distance between the inner edge and a surface of the center electrode is 0.3 mm or greater.

According to this configuration, spark discharge is restrained from passing through the surface of the insulator. Therefore, the durability of the spark plug can be enhanced.

### Application Example 2

In the spark plug described in the application example 1, the distance between the inner edge and the surface of the center electrode is 0.35 mm or greater.

According to this configuration, spark discharge is more effectively restrained from passing through the surface of the insulator.

### Application Example 3

In the spark plug described in the application example 1 or 2,

when a position separated from an edge of an end surface of the center electrode on the forward end side by 5 mm in a direction orthogonal to the axial line is defined as a first position, a position on the inner edge of the insulator is defined as a second position, a position of intersection between the surface of the center electrode and a straight line is defined as a third position, as viewed on a cross section including the axial line, the straight line passing through the first position and being tangent, at one position, to a forward-end-side portion of a contour of the insulator on a side toward the first position with respect to the center axis, a distance between the third position and the second position in a direction parallel to the axial line is defined as a first distance, and a distance between the second position and the end of the joint portion on the forward end side in the direction parallel to the axial line is defined as a second distance,

a difference obtained by subtracting the first distance from the second distance is equal to or greater than zero mm.

According to this configuration, even when spark discharge moves due to gas flow, spark discharge is restrained from reaching the joint portion. Therefore, the durability of the spark plug can be enhanced.

### Application Example 4

A spark plug comprising:

a tubular insulator having an axial hole extending therethrough along an axial line;

a center electrode disposed at an end of the axial hole on a forward end side; and

a rod-shaped ground electrode forming a gap between the ground electrode and a portion of the center electrode on the forward end side, wherein

the center electrode includes a shaft portion, a tip portion joined to a forward end portion of the shaft portion, and a joint portion joining the shaft portion and the tip portion together;

an end of the joint portion on the forward end side is located on a rear end side in the direction of the axial line in relation to an inner edge of the insulator, which is a forward-end-side edge of an inner circumferential surface of a small diameter portion of the insulator, the small diameter portion being a part of an accommodation portion of the insulator for accommodating the tip portion, which part has the smallest inner diameter in the accommodation portion; and

when a position separated from an edge of an end surface of the center electrode on the forward end side by 5 mm in a direction orthogonal to the axial line is defined as a first position, a position on the inner edge of the insulator is defined as a second position, a position of intersection between the surface of the center electrode and a straight line is defined as a third position, as viewed on a cross section including the axial line, the straight line passing through the first position and being tangent, at one position, to a forward-end-side portion of a contour of the insulator on a side toward the first position with respect to the center axis, a distance between the third position and the second position in a direction parallel to the axial line is defined as a first distance, and a distance between the second position and the end of the joint portion on the forward end side in the direction parallel to the axial line is defined as a second distance,

a difference obtained by subtracting the first distance from the second distance is equal to or greater than zero mm.

According to this configuration, even when spark discharge moves due to gas flow, spark discharge is restrained from reaching the joint portion. Therefore, the durability of the spark plug can be enhanced.

### Application Example 5

In the spark plug described in the application example 4, the difference is 0.3 mm or greater.

According to this configuration, spark discharge is more effectively restrained from reaching the joint portion.

### Application Example 6

In the spark plug described in the application example 4 or 5, a distance between the inner edge and a surface of the center electrode is 0.3 mm or greater.

According to this configuration, spark discharge is restrained from passing through the surface of the insulator. Therefore, the durability of the spark plug can be enhanced.

### Application Example 7

In the spark plug described in any of the application examples 1 to 6, the length of a portion of the center electrode located on the forward end side in relation to a forward end of the insulator as measured in a direction parallel to the axial line is 1 mm or greater.

According to this configuration, even when spark discharge moves due to gas flow, spark discharge is restrained from reaching the joint portion. Also, spark discharge is restrained from passing through the surface of the insulator. Therefore, the durability of the spark plug can be enhanced.

### Application Example 8

In the spark plug described in any of the application examples 1 to 7, the tip portion has a generally circular columnar shape extending along the axial line, and the tip portion has an outer diameter of 0.7 mm or greater.

According to this configuration, expansion of the gap due to consumption of the tip portion is restrained. Therefore, the durability of the spark plug can be enhanced.

### Application Example 9

An ignition system comprising:

a spark plug according to any one of the application examples 1 to 8; and

a power supply circuit for supplying electrical energy to the gap of the spark plug,

spark discharge being generated at the gap as a result of supply of electrical energy to the gap from the power supply circuit,

wherein the power supply circuit outputs an energy of 100 mJ or greater for generation of spark discharge in each single ignition stroke.

According to this configuration, the durability of the spark plug can be enhanced, and the ignition performance of the spark plug can be enhanced by using the output energy of the power supply circuit.

Notably, the present invention can be realized in various forms. For example, the present invention can be realized as an internal combustion engine including an ignition system mounted thereon.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a schematic diagram of an example of an ignition system.

FIG. 2 is a sectional view of an example of a spark plug.

FIG. 3 is a sectional view showing a gap g and the vicinity thereof.

FIG. 4 is a sectional view showing forward end portions of an insulator 10 and a center electrode 20.

FIG. 5 is a graph showing the results of a second evaluation test.

FIG. 6 is a graph showing the results of a third evaluation test.

FIG. 7 is a schematic view of a spark plug 100b of a second embodiment.

### DETAILED DESCRIPTION OF THE INVENTION

### Modes for Carrying Out the Invention

### A. First Embodiment

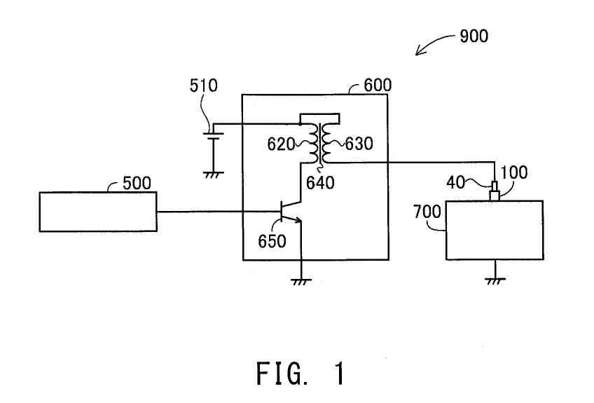

FIG. 1 is a schematic diagram of an example of an ignition system. An ignition system 900, an internal combustion engine 700, a controller 500 for the internal combustion engine 700, and a battery 510 are shown in FIG. 1. The ignition system 900 includes a spark plug 100 attached to the internal combustion engine 700, and a power supply circuit 600 for supplying electrical energy to the spark plug 100. Although the single spark plug 100 is shown in FIG. 1, in actuality, the spark plug 100 is attached to each of N cylinders of the internal combustion engine 700 (N is an integer equal to or greater than 1). The electrical energy from the power supply circuit 600 is supplied to each spark plug 100 through an unillustrated distributor. Notably, a plurality of spark plugs 100 may be attached to each cylinder. Also, electrical energy may be supplied from the power supply circuit 600 to the spark plug 100 without use of a distributor (for example, direct ignition).

The power supply circuit 600 causes generation of spark discharge at a gap (which will be described later) of the spark plug 100 by supplying electrical energy to the spark plug 100. The power supply circuit 600 includes a core 640, a primary coil 620 which is wound around the core 640, and a secondary coil 630 which is wound around the core 640 and whose number of turns is greater than that of the primary coil 620, and an igniter 650.

One end of the primary coil 620 is connected to the battery 510, and the other end of the primary coil 620 is connected to the igniter 650. One end of the secondary coil 630 is connected to the end of the primary coil 620 on the battery 510 side, and the other end of the secondary coil 630 is connected to a metallic terminal 40 of the spark plug 100.

The igniter 650 is a so-called switching device, and is an electric circuit including, for example, a transistor. The igniter 650 establishes and breaks electrical communication or continuity between the primary coil 620 and the battery 510 in accordance with a control signal from the controller 500. When the igniter 650 establishes the electrical communication, a current flows from the battery 510 to the primary coil 620, whereby a magnetic field is formed around the core 640. When the igniter 650 breaks the electrical communication after that, the current flowing through the primary coil 620 is cut off, and the magnetic field changes. As a result, a voltage is produced in the primary coil 620 due to self-induction, and a higher voltage is produced in the secondary coil 630 due to mutual induction. This high voltage (i.e., electrical energy) is supplied from the secondary coil 630 to the gap of the spark plug 100. As a result, spark discharge is produced at the gap.

The power supply circuit 600 can output an energy of 100 mJ or more to one spark plug 100 during a single ignition stroke. The single ignition stroke means the ignition stroke in one operational cycle of one cylinder of the internal combustion engine 700. In the case where spark discharge is produced one time during the one operational cycle, the energy output for producing spark discharge one time corresponds to the output energy for a single ignition stroke. In the case where spark discharge is produced a plurality of times during the one operational cycle, the total of energies each output for producing each spark discharge corresponds to the output energy for a single ignition stroke. Notably, the output energy shows the energy output from the power supply circuit 600. The energy actually received by the spark plug 100 may be smaller than the output energy because of attenuation at a cable connecting the power supply circuit 600 and the spark plug 100.

Next, the structure of the spark plug 100 will be described.

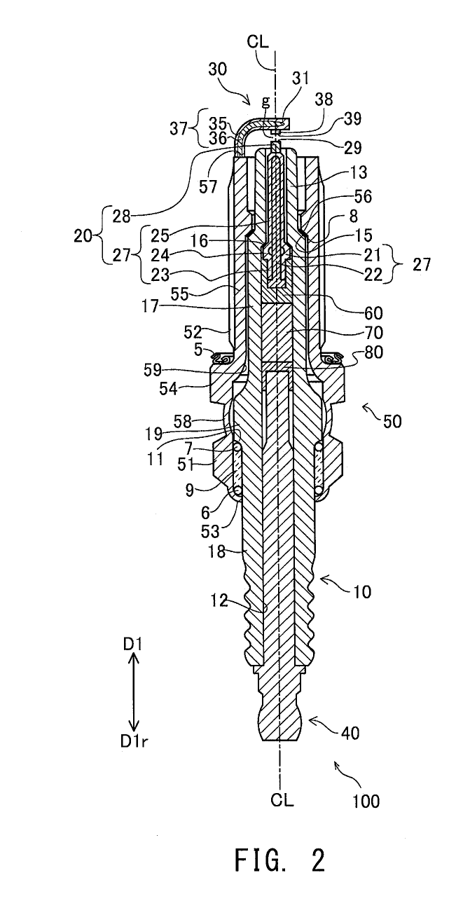

FIG. 2 is a sectional view of an example of a spark plug. A line CL shown in FIG. 2 represents the center axis of the spark plug 100. The illustrated section contains the center axis CL. In the following description, the center axis CL will also be referred to as the “axial line CL,” and the direction parallel to the center axis CL will also be referred to as the “axial direction.” The radial direction of a circle whose center is located at the center axis CL will simply be referred to the “radial direction,” and the circumferential direction of a circle whose center is located at the center axis CL will simply be referred to the “circumferential direction.” Of directions parallel to the center axis CL, the upward direction in FIG. 2 will be referred to as a forward direction D1, and the downward direction will be referred to as a rearward direction D1r. The forward direction D1 is a direction from a metallic terminal 40 toward electrodes 20 and 30 which will be described later. The forward direction D1 side of FIG. 2 will be referred to as the forward end side of the spark plug 100, and the rearward direction D1r side of FIG. 2 will be referred to as the rear end side of the spark plug 100.

The spark plug 100 includes an insulator 10 (hereinafter also referred to as the “ceramic insulator 10”), a center electrode 20, a ground electrode 30, a metallic terminal 40, a metallic shell 50, an electrically conductive first seal portion 60, a resistor 70, an electrically conductive second seal portion 80, a forward-end-side packing 8, talc 9, a first rear-end-side packing 6, and a second rear-end-side packing 7.

The insulator 10 is a generally cylindrical member having a through hole 12 (hereinafter also referred to as the “axial hole 12”) extending along the center axis CL and penetrating the insulator 10. The insulator 10 is formed by firing alumina (other insulating materials can be employed). The insulator 10 has a leg portion 13, a first outer-diameter decreasing portion 15, a forward-end-side trunk portion 17, a flange portion 19, a second outer-diameter decreasing portion 11, and a rear-end-side trunk portion 18, which are arranged in this order from the forward end side toward the rearward direction D1r side. The outer diameter of the first outer-diameter decreasing portion 15 decreases gradually from the rear end side toward the forward end side. An inner-diameter decreasing portion 16 whose inner diameter decreases gradually from the rear end side toward the forward end side is formed in the vicinity of the first outer-diameter decreasing portion 15 of the insulator 10 (at the forward-end-side trunk portion 17 in the example of FIG. 2). The outer diameter of the second outer-diameter decreasing portion 11 decreases gradually from the forward end side toward the rear end side.

The rod-shaped center electrode 20 extending along the center axis CL is inserted into a forward end portion of the axial hole 12 of the insulator 10. The center electrode 20 has a shaft portion 27 and a generally circular columnar first tip portion 28 whose center coincides with the center axis CL and which extends along the center axis CL. The shaft portion 27 has a leg portion 25, a flange portion 24, and a head portion 23 which are arranged in this order from the forward end side toward the rearward direction D1r side. The first tip portion 28 is joined to the forward end of the leg portion 25 (namely, the forward end of the shaft portion 27) (by means of, for example, laser welding). A forward end portion of the first tip portion 28 projects from the axial hole 12 on the forward end side of the insulator 10. A surface of the flange portion 24 on the forward direction D1 side is supported by the inner-diameter decreasing portion 16 of the insulator 10. The shaft portion 27 includes an outer layer 21 and a core 22. The outer layer 21 is formed of a material which is higher in oxidation resistance than the core 22; namely, a material which consumes little when it is exposed to combustion gas within a combustion chamber of an internal combustion engine (for example, pure nickel, an alloy containing nickel and chromium, etc.). The core 22 is formed of a material (for example, pure copper, a copper alloy, etc.) which is higher in thermal conductivity than the outer layer 21. A rear end portion of the core 22 is exposed from the outer layer 21, and forms a rear end portion of the center electrode 20. The remaining portion of the core 22 is covered with the outer layer 21. However, the entirety of the core 22 may be covered with the outer layer 21. The first tip portion 28 is formed of a material which is higher in durability against discharge than the shaft portion 27. Examples of such a material include noble metals (e.g., iridium (Ir), platinum (Pt), or the like), tungsten (W), and an alloy containing at least one type of metal selected from these metals.

A portion of the metallic terminal 40 is inserted into a rear end portion of the axial hole 12 of the insulator 10. The metallic terminal 40 is formed of an electrically conductive material (for example, metal such as low-carbon steel).

The resistor 70, which has a generally circular columnar shape and is adapted to suppress electrical noise, is disposed in the axial hole 12 of the insulator 10 to be located between the metallic terminal 40 and the center electrode 20. The resistor 70 is formed through use of, for example, a material containing an electrically conductive material (e.g., particles of carbon), particles of ceramic (e.g., ZrO₂), and particles of glass (e.g., particles of SiO₂—B₂O₃—Li₂O—BaO glass). The electrically conductive first seal portion 60 is disposed between the resistor 70 and the center electrode 20, and the electrically conductive second seal portion 80 is disposed between the resistor 70 and the metallic terminal 40. The seal portions 60 and 80 are formed through use of a material containing, for example, particles of glass similar to that contained in the material of the resistor 70 and particles of metal (e.g., Cu). The center electrode 20 and the metallic terminal 40 are electrically connected through the resistor 70 and the seal portions 60 and 80.

The metallic shell 50 is a generally cylindrical member having a through hole 59 which extends along the center axis CL and penetrates the metallic shell 50. The metallic shell 50 is formed of low-carbon steel (other electrically conductive materials (e.g., metallic material) can be employed). The insulator 10 is inserted into the through hole 59 of the metallic shell 50. The metallic shell 50 is fixed to the outer periphery of the insulator 10. On the forward end side of the metallic shell 50, a forward end of the insulator 10 (a forward end portion of the leg portion 13 in the present embodiment) projects from the through hole 59. On the rear end side of the metallic shell 50, a rear end of the insulator 10 (a rear end portion of the rear-end-side trunk portion 18 in the present embodiment) projects from the through hole 59.

The metallic shell 50 has a trunk portion 55, a seat portion 54, a deformable portion 58, a tool engagement portion 51, and a crimp portion 53 arranged in this order from the forward end side toward the rear end side. The seat portion 54 is a flange-shaped portion. A screw portion 52 for screw engagement with an attachment hole of an internal combustion engine (e.g., gasoline engine) is formed on the outer circumferential surface of the trunk portion 55. An annular gasket 5 formed by bending a metal plate is fitted between the seat portion 54 and the screw portion 52.

The metallic shell 50 has an inner-diameter decreasing portion 56 disposed on the forward direction D1 side of the deformable portion 58. The inner diameter of the inner-diameter decreasing portion 56 decreases gradually from the rear end side toward the forward end side. The forward-end-side packing 8 is sandwiched between the inner-diameter decreasing portion 56 of the metallic shell 50 and the first outer-diameter decreasing portion 15 of the insulator 10. The forward-end-side packing 8 is an O-ring formed of iron (other materials (e.g., metallic material such as copper) can be employed).

The tool engagement portion 51 has a shape (e.g., a hexagonal column) suitable for engagement with a spark plug wrench. The crimp portion 53 is disposed on the rear end side of the second outer-diameter decreasing portion 11 of the insulator 10, and forms a rear end (an end on the rearward direction D1r side) of the metallic shell 50. The crimp portion 53 is bent radially inward. On the rearward direction D1r side of the crimp portion 53, the first rear-end-side packing 6, the talc 9, and the second rear-end-side packing 7 are disposed between the inner circumferential surface of the metallic shell 50 and the outer circumferential surface of the insulator 10 in this order toward the forward direction D1 side. In the present embodiment, these rear-end-side packings 6 and 7 are C-rings formed of irons (other materials can be employed).

When the spark plug 100 is manufactured, crimping is performed such that the crimp portion 53 is bent inward. Thus, the crimp portion 53 is pressed toward the forward direction D1 side. As a result, the deformable portion 58 deforms, and the insulator 10 is pressed forward within the metallic shell 50 via the packings 6 and 7 and the talc 9. The forward-end-side packing 8 is pressed between the first outer-diameter decreasing portion 15 and the inner-diameter decreasing portion 56 to thereby establish a seal between the metallic shell 50 and the insulator 10. By virtue of the above-described configuration, the metallic shell 50 is fixed to the insulator 10.

The ground electrode 30 has a rod-shaped shaft portion 37, and a generally circular columnar second tip portion 38 whose center coincides with the center axis CL. One end of the shaft portion 37 is joined to a forward end 57 (i.e., an end 57 on the forward direction D1 side) of the metallic shell 50 (by means of, for example, resistance welding). The shaft portion 37 extends in the forward direction D1 from the forward end 57 of the metallic shell 50, bends toward the center axis CL, and has a distal end portion 31. The second tip portion 38 is joined to a part of the outer surface of the distal end portion 31, which part faces the center electrode 20 (by means of, for example, laser welding). A rear end surface 39 (i.e., a surface 39 on the rear direction D1r side) of the second tip portion 38 forms a gap g in cooperation with a forward end surface 29 (i.e., a surface 29 on the forward direction D1 side) of the first tip portion 28. The shaft portion 37 has a base member 35 which forms the surface of the shaft portion 37, and a core 36 embedded in the base member 35. The base member 35 is formed of a material which is excellent in oxidation resistance (for example, an alloy containing nickel and chromium). The core 36 is formed of a material (for example, pure copper) which is higher in thermal conductivity than the base member 35. The second tip portion 38 is formed of a material which is higher in durability against discharge than the shaft portion 37. Examples of such a material include noble metals (e.g., iridium (Ir), platinum (Pt), or the like), tungsten (W), and an alloy containing at least one type of metal selected from these metals.

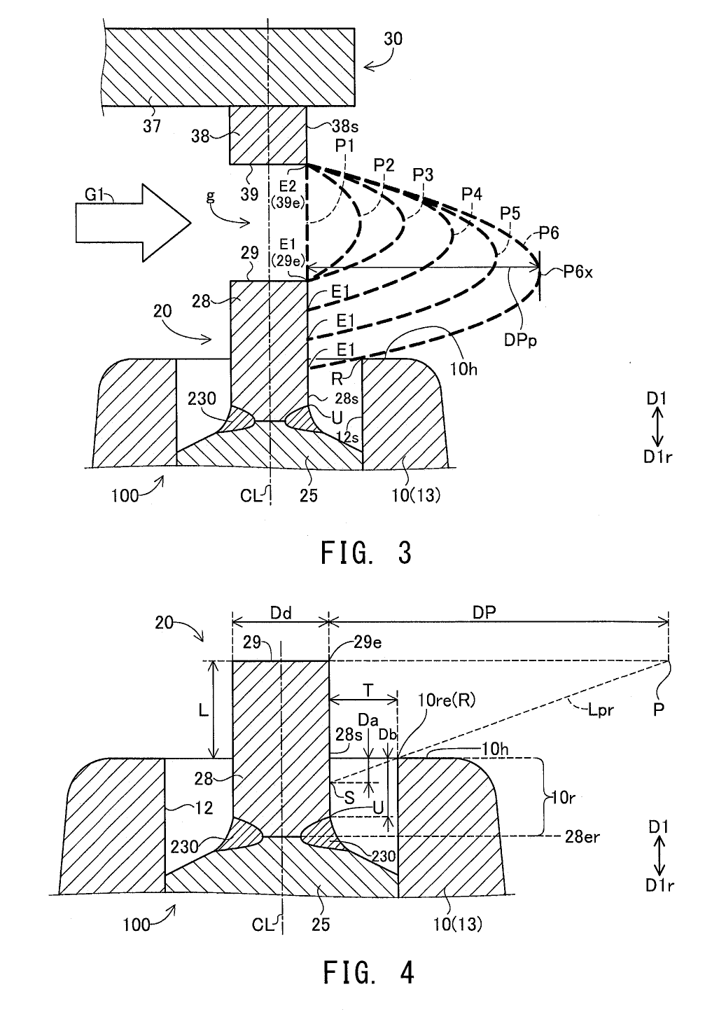

FIG. 3 is a sectional view of portions of the insulator 10, the center electrode 20, and the ground electrode 30 in the vicinity of the gap g. In the drawing, a cross section including the center axis CL is shown. In the present embodiment, the first tip portion 28 is welded to the end of the leg portion 25 of the center electrode 20 on the forward direction D1 side. A joint portion 230 in the drawing is a portion formed as a result of melting at the time of welding. The joint portion 230 is in contact with the leg portion 25 and the first tip portion 28, and connects the leg portion 25 and the first tip portion 28 together. In the present embodiment, the leg portion 25 and the first tip portion 28 are laser-welded together at the interface therebetween and over the entire circumference thereof.

The joint portion 230 is located on the rearward direction D1r side in relation to the forward end surface 10h of the insulator 10. The first tip portion 28 protrudes outward from the through hole 12. Namely, a portion of the center electrode 20 located outside the through hole 12 (i.e., on the forward direction D1 side in relation to the forward end surface 10h of the insulator 10) is only a portion of the first tip portion 28. Accordingly, it is possible to restrain generation of spark discharge at portions of the center electrode 20 other than the first tip portion 28.

A forward end portion of the leg portion 25 of the center electrode 20 is located within the through hole 12 at the leg portion 13 of the insulator 10. The outer diameter of the leg portion 25 of the center electrode 20 is slightly smaller than the inner diameter of the through hole 12 at the leg portion 13 of the insulator 10. For example, the leg portion 13 of the insulator 10 and the leg portion 25 of the center electrode 20 are configured such that a difference obtained by subtracting the outer diameter of the leg portion 25 of the center electrode 20 from the inner diameter of the through hole 12 at the leg portion 13 of the insulator 10 falls within a range of 0.01 mm to 0.2 mm. Meanwhile, the outer diameter of the first tip portion 28 is smaller than the outer diameter of the leg portion 25 of the center electrode 20. A gap is formed between the side surface 28s of the first tip portion 28 and the wall surface 12s of the through hole 12. Since a forward end portion of the insulator 10 is separated from the first tip portion 28, it is possible to restrain spark discharge generated at the first tip portion 28 from coming into contact with the insulator 10.

An arrow G1 in the drawing shows a flow of gas in the vicinity of the gap g (namely, a flow of gas within a cylinder of an internal combustion engine) (hereinafter referred to as “gas flow G1”). This gas flow G1 passes through the gap g along a direction approximately orthogonal to the center axis CL. Such gas flow G1 may occur in cylinders of internal combustion engines of various types. Spark discharge generated at the gap g is blown leeward by the gas flow G1. Discharge paths P1 through P6 in the drawing show examples of paths of spark discharge. A first path P1 is an example of a path in the case where spark discharge is not blown by the gas flow G1, and is approximately parallel to the center axis CL extending from the rear end surface 39 of the second tip portion 38 to the forward end surface 29 of the first tip portion 28. A second path P2 through a sixth path P6 are examples of paths in the case where spark discharge is blown by the gas flow G1. Each of the shapes of these paths P2 through P6 is the shape of an arch projecting toward the leeward side (the right side of FIG. 3). The greater the path number (the number assigned to each path), the greater the distance over which spark discharge is blown from the center axis CL.

Distance DPp in the drawing represents the degree to which spark discharge is blown by the gas flow G1 in the case where the spark discharge occurs along the sixth path P6; namely, the degree of deflection of the sixth path P6 toward the leeward side. Specifically, the distance DPp is a distance (in the direction orthogonal to the center axis CL) between the edge 29e of the forward end surface 29 of the center electrode 20 (i.e., the forward end surface 29 of the first tip portion 28) and a position P6x on the discharge path (the sixth path P6 in the present example). Among positions on the discharge path, the position P6x is the furthest from the center axis CL. The greater the distance DPp, the greater the degree to which spark discharge path is blown by the gas flow G1. For other discharge paths (for examples, discharge paths P1 through P5), the distance DPp can be determined in the same manner. In the following description, such distance DPp will be referred to as “flow distance DPp.”

In recent years, the speed of the gas flow G1 tends to be increased in order to improve the performance (e.g., fuel economy) of an internal combustion engine. The flow distance DPp tends to increase with the speed of the gas flow G1. However, when the speed of the gas flow G1 is high, spark discharge is likely to be interrupted. Such interruption of spark discharge can be prevented by increasing the electrical energy supplied to the spark plug 100 by the power supply circuit 600 in each single ignition stroke. For example, as described above, the power supply circuit 600 can output energy of 100 mJ or greater in each single ignition stroke. Therefore, even when the speed of the gas flow G1 is high, interruption of spark discharge is prevented. As a result, even when the speed of the gas flow G1 is high, deterioration in ignition performance can be prevented. Also, the large flow distance DPp can be realized. For example, when the flow speed is 10 m/sec, the flow distance DPp may reach 5 mm.

Ends E1 and E2 shown in FIG. 3 are opposite ends of each discharge path. The first end E1 is an end on the surface of the center electrode 20, and the second end E2 is an end on the surface of the ground electrode 30. Since the discharge path hardly bends sharply, the greater the flow distance DPp, the greater the distance between the first end E1 and the second end E2 as measured in the direction parallel to the center axis CL. As shown by the fourth path P4 through the sixth path P6, when the flow distance DPp is large, the first end E1 may move to the side surface of the center electrode 20 (the side surface 28s of the first tip portion 28 in the present embodiment). The greater the flow distance DPp, the greater the distance over which the first end E1 moves toward the rearward direction D1r side. Notably, in FIG. 3, the second ends E2 of all the discharge paths P1 through P6 are located at the edge 39e of the rear end surface 39 of the second tip portion 38. However, the second ends E2 may move to the side surface 38s of the second tip portion 38.

As shown by the sixth path P6, when the flow distance DPp is considerably large, the discharge path may come into contact with the forward end surface 10h of the ceramic insulator 10. In this case, the forward end of the insulator 10 may consume. Accordingly, it is preferred that the discharge path be separated from the insulator 10. Also, in the case where the joint portion 230 is located on the forward direction D1 side in relation to the position in FIG. 3, the first end E1 of the discharge path may be located on the joint portion 230. The joint portion 230 is often lower in durability against discharge as compared with the first tip portion 28. In the case where the first end E1 of the discharge path is located on the joint portion 230, consumption of the center electrode 20 may proceed quickly. Accordingly, it is preferred that the joint portion 230 be disposed on the rearward direction D1r side of the position which the first end E1 of the discharge path may reach.

### B. Evaluation Tests

### B-1. First Evaluation Test

There was performed a test for determining the relation among the output energy from the power supply circuit 600 (FIG. 1), the configuration of the spark plug 100 (FIG. 3), and discharge path. First, parameters for specifying the configuration of the spark plug 100 will be described. FIG. 4 is a sectional view of the front end portions of the insulator 10 and the center electrode 20. A cross section containing the center axis CL is shown in the drawing.

Four positions P, R, S, U and a straight line Lpr are shown in the drawing. The first position P is a position shifted, by a predetermined distance DP (hereinafter referred to as a “reference distance DP”), from the edge 29e of the forward end surface 29 of the center electrode 20 (i.e., the forward end surface 29 of the first tip portion 28) in a direction orthogonal to the center axis CL (radially outward direction). The second position R is a position on an inner edge 10re, which is an edge of the axial hole 12 of the insulator 10 on the forward direction D1 side. In the embodiment of FIG. 4, the second position R is the same as the position of the inner-peripheral-side edge of the forward end surface 10h of the insulator 10. The straight line Lpr is a straight line which passes through the first position P and is tangent, at one position, to a forward-end-side portion of the contour (contour on the side toward the first position P with respect to the center axis CL) of the insulator 10. Namely, this straight line Lpr is in contact with the contour of the insulator 10 without crossing it. In the embodiment of FIG. 4, the straight line Lpr is a straight line passing through the first position P and the second position R. The third position S is a position at which the straight line Lpr crosses the surface (surface on the side toward the first position P with respect to the center axis CL) of the center electrode 20.

The first position P, the third position S, and the reference distance DP are set for an assumed discharge path (e.g. the sixth path P6 of FIG. 3) which may come into contact with the insulator 10. The first position P corresponds to a position on the discharge path which is the furthest from the center axis CL among positions on the discharge path (e.g., the position P6x on the sixth path P6 of FIG. 3). The reference distance DP corresponds to the flow distance DPp (FIG. 3). The third position S corresponds to the first end E1 of the discharge path (FIG. 3). A discharge path extending to the vicinity of the first position P may come into contact with the insulator 10 at, for example, the second position R. Also, such a discharge path may come into contact with the center electrode 20 at, for example, the third position S.

The fourth position U is a position of an end of the joint portion 230 (specifically, the outer surface of the joint portion 230) on the forward direction D1 side. In the example of FIG. 4, the third position S is located on the forward direction D1 side of the fourth position U; namely, is located on the surface of the first tip portion 28. However, depending on the configuration of the center electrode 20, the third position S may be located on the surface of the joint portion 230 or the surface of the leg portion 25.

In the following description, the reference distance DP is assumed to be 5 mm. 5 mm is the flow distance DPp which is realized when the speed of the gas flow G1 (FIG. 3) is 10 m/sec, which is faster than that in a conventional internal combustion engine. As will be described later, by configuring the spark plug 100 in such a manner that the third position S is located on the forward direction D1 of the fourth position U when the reference distance DP is determined as described above, consumption of the joint portion 230 (i.e., consumption of the center electrode 20) is suppressed even when spark discharge (discharge path) is blown greatly by the gas flow G1.

Also, a projection length L, a first distance Da, a second distance Db, and a separation distance T are shown in FIG. 4. The projection length L is a length (as measured in a direction parallel to the center axis CL) of a portion of the center electrode 20, which portion is located on the forward direction D1 side of the forward end of the insulator 10 (which is the same as the forward end surface 10h in the example of FIG. 4). Namely, the projection length L is the length of a portion of the center electrode 20 projecting from the insulator 10 toward the forward direction D1 side. The longer the projection length L, the greater the degree to which spark discharge is restrained from coming into contact with the insulator 10 even when the speed of the gas flow G1 (FIG. 3) is high.

The first distance Da is the distance between the second position R and the third position S as measured in a direction parallel to the center axis CL. The second distance Db is the distance between the second position R and the fourth position U as measured in a direction parallel to the center axis CL. In the example of FIG. 4, the fourth position U is located on the rearward direction D1r side of the third position S. Accordingly, the difference (Db-Da) obtained by subtracting the first distance Da from the second distance Db is greater than zero. Notably, as will be described later, in this case, it is possible to prevent spark discharge from coming into contact with the joint portion 230.

The separation distance T is the shortest distance between the inner edge 10re and the surface of the center electrode 20. In the present embodiment, the separation distance T is a distance as measured in a direction orthogonal to the center axis CL. In the example of FIG. 4, the separation distance T is the distance between the inner edge 10re and the side surface 28s of the first tip portion 28. As will be described later, the greater the separation distance T, the greater the degree to which spark discharge is restrained from passing through the surface of the insulator 10.

An evaluation test was performed by using a plurality of samples of the spark plug 100 which differed from one another in terms of the configuration determined by the above-mentioned parameters. The evaluation test was performed by using the ignition system 900 (the power supply circuit 600 and the spark plug 100) and the battery 510 shown in FIG. 1. Each sample of the spark plug 100 is disposed in an environment in which the gas flow G1 (flow of air in the test) passes through the gap g. In this state, the power supply circuit 600 supplied electrical energy to the spark plug 100 so as to generate spark discharge at the gap g of the spark plug 100. The following Table 1 shows the relation among the number of test conditions, the output energy (unit: mJ) from the power supply circuit 600, the position of the joint portion 230 in relation to the insulator 10, the separation distance T, the movement of spark discharge, the result of evaluation on the possibility of spark flying to the joint portion 230, the results of evaluation on the possibility of channeling, the difference of distance (Db-Da). As shown in the table, evaluation was performed for nine types of conditions; i.e., conditions No. 1 through No. 9. Notably, the following parameters were common among the nine types of conditions.

Speed of the gas flow G1: 10 m/sec

Projection length L: 1 mm

Outer diameter Dd of the first tip portion 28: 0.7 mm

Reference distance DP: 5 mm

TABLE 1

| | | Position of | | Spark | | | |
|---|---|---|---|---|---|---|---|
| | Output | joint portion | | movement | Spark flying | | |
| | energy | relative to | T | due to gas | to joint | | Db-Da |
| No. | (mJ) | insulator | (mm) | flow | portion | Channeling | (mm) |
| 1 | 80 | Outside | 0.1 | Not occurred | A | A | — |
| 2 | 90 | Outside | 0.1 | Not occurred | A | A | — |
| 3 | 100 | Outside | 0.1 | Occurred | B | B | — |
| 4 | 100 | Inside | 0.1 | Occurred | A | B | 0 |
| 5 | 100 | Inside | 0.3 | Occurred | A | A | 0 |
| 6 | 100 | Inside | 0.45 | Occurred | A | A | 0 |
| 7 | 150 | Inside | 0.3 | Occurred | A | A | 0 |
| 8 | 200 | Inside | 0.3 | Occurred | A | A | 0 |
| 9 | 100 | Inside | 0.3 | Occurred | A | A | −0.1 |

The output energy from the power supply circuit 600 shows the energy output in each single ignition stroke. In the present evaluation test, discharge was produced one time in each single ignition stroke. Namely, the energy shown in Table 1 is the energy output for a single discharge. As shown in Table 1, the output energies of the conditions No. 1 through No. 9 were 80, 90, 100, 100, 100, 100, 150, 200, and 100 (mJ), respectively.

The position of the joint portion 230 in relation to the insulator 10 is selected from “outside” and “inside.” The “outside” means that at least a portion of the joint portion 230 is located on the forward direction D1 side in relation to the forward end of the insulator 10 (specifically, the forward end surface 10h; i.e., the second position R). Namely, the “outside” means that the fourth position U is located on the forward direction D1 side in relation to the forward end of the insulator 10. The “inside” means that the entire joint portion 230 is located on the rearward direction D1r side in relation to the forward end of the insulator 10. Namely, the “inside” means that the fourth position U is located on the rearward direction D1r side in relation to the forward end of the insulator 10 (specifically, the second position R).

The separation distance T is the separation distance T described with reference to FIG. 4. As shown in Table 1, the separation distances T of the conditions No. 1 through No. 9 were 0.1, 0.1, 0.1, 0.1, 0.3, 0.45, 0.3, 0.3, and 0.3 (mm), respectively. The adjustment of the separation distance T was performed by adjusting the inner diameter of the through hole 12 without changing the outer diameter Dd of the first tip portion 28.

The movement of spark discharge shows whether or not spark discharge moved due to the gas flow G1. In the present evaluation test, paths of a predetermined number (specifically, 100 times) of times of test discharges were photographed through use of a high speed camera, and the flow distance DPp was determined from each of the photographed images. In the case where the flow distance DPp was 5 mm or greater in at least one test discharge, it was determined that movement of spark discharge occurred. In the case where the flow distance DPp was less than 5 mm in all the test discharges, it was determined that movement of spark discharge did not occur.

The spark flying to the joint portion 230 means that spark discharge moves to the joint portion 230. The possibility of spark flying to the joint portion 230 was evaluated by disassembling the spark plug after the above-described predetermined number of times of test discharges, and observing the surface of the joint portion 230 under a scanning electron microscope (SEM). The possibility of spark flying to the joint portion 230 was evaluated on the basis of the following criteria. Rank “A” shows that no discharge mark was observed. Rank “B” shows that a discharge mark was observed.

The channeling means that spark discharge comes into contact with the insulator 10; namely, spark discharge passes through the surface of the insulator 10. The possibility of channeling was evaluated on the basis of the following criteria. Namely, rank A shows that a groove having a depth of 0.05 mm or greater was not formed on the surface (in particular, on the forward end surface 10h) of the insulator 10 as a result of the above-described predetermined number of times of test discharges. Rank B shows that a groove having a depth of 0.05 mm or greater was formed on the surface (in particular, on the forward end surface 10h) of the insulator 10 as a result of the above-described predetermined number of times of test discharges.

The distance difference Db−Da is the difference between the first distance Da and the second distance Db shown in FIG. 4 (the distance difference Db−Da is obtained by subtracting the first distance Da from the second distance Db). As shown in Table 1, for the conditions No. 1 through No. 3 in which the position of the joint portion 230 in relation to the insulator 10 is “outside,” the distance difference Db−Da is omitted. The distance differences Db-Da of the conditions No. 4 through No. 8 were 0 mm. The distance difference Db−Da of the condition No. 9 was −0.1 mm. The fact that the distance difference Db−Da is negative means that the third position S is located on the rearward direction D1r side in relation to the fourth position U. In the condition No. 9, the third position S was located on the surface of the joint portion 230.

Notably, as shown in Table 1, the distance differences Db-Da of the conditions No. 4 through No. 8 were 0 mm irrespective of the separation distance T. As can be understood from FIG. 4, when the separation distance T is increased without changing the outer diameter Dd of the first tip portion 28, the second position R approaches to the first position P, and therefore, the third position S moves toward the rearward direction D1r side. As a result, the first distance Da increases. In the present evaluation test, when the first distance Da increased, the fourth position U (i.e., the joint portion 230) was moved toward the rearward direction D1r side by extending the first tip portion 28 toward the rearward direction D1r side. In this manner, the distance difference Db−Da=0 mm was realized for the various separation distances T of the conditions No. 4 through No. 8.

As shown in Table 1, in the case of the conditions No. 1 and 2 where the output energy was less than 100 mJ (specifically, 80 mJ, 90 mJ), movement of spark discharge due to gas flow was not observed, the possibility of spark flying to the joint portion was evaluated as rank A, and the possibility of channeling was also evaluated as rank A. This is because spark discharge was interrupted before the flow distance DPp became large because the output energy was small.

In the case of the conditions No. 3 through No. 9 where the output energy was 100 mJ or greater, movement of spark discharge due to gas flow occurred. The reason why movement of spark discharge occurred is that the large output energy prevented the interruption of spark discharge, whereby a large flow distance DPp was realized.

Of the conditions No. 3 through NO. 9 under which movement of spark discharge due to gas flow occurred, the condition No. 3 produced an evaluation result different from those produced by the condition No. 4 through the condition No. 9 in terms of the possibility of spark flying to the joint portion 230. Specifically, in the case of the condition No. 3 in which the joint portion 230 is located outside the insulator 10, the possibility of spark flying to the joint portion 230 was evaluated as rank B. Meanwhile, in the case of the condition No. 4 through the condition No. 9 in which the joint portion 230 is located inside the insulator 10, the possibility of spark flying to the joint portion 230 was evaluated as rank A. As described above, when the joint portion 230 was disposed within the through hole 12 of the insulator 10, the possibility of spark discharge reaching the joint portion 230 was able to be decreased. Also, in the case where the distance difference Db−Da is negative (condition No. 9) as well, rank A was able to be realized for the possibly of spark flying to the joint portion 230. It is expected that the possibility of spark discharge reaching the joint portion 230 can be decreased irrespective of the distance difference Db−Da when the joint portion 230 is disposed inside the insulator 10 as described above.

Also, of the conditions No. 3 through NO. 9 under which movement of spark discharge due to gas flow occurred, the condition No. 3 and the condition No. 4 produced an evaluation result different from those produced by the condition No. 5 through the condition No. 9 in terms of the possibility of channeling. Specifically, in the case of the condition No. 3 and the condition No. 4 in which the separation distance T is 0.1 mm, the possibility of channeling was evaluated as rank B. Meanwhile, in the case of the condition No. 5 through the condition No. 9 in which the separation distance T is 0.3 mm or greater, the possibility of channeling was evaluated as rank A. As described above, the possibility of channeling was able to be decreased by increasing the separation distance T. Notably, the separation distances T for which the possibility of channeling was evaluated as rank A were 0.3 and 0.45 (mm). A value arbitrarily selected from these values can be employed as a lower limit of a preferred range (ranging from the lower limit to an upper limit) of the separation distance T. For example, a value equal to or greater than 0.3 mm can be employed as the separation distance T. An arbitrary value greater than the lower limit can be employed as the upper limit. For example, a value equal to or less than 0.45 mm can be employed as the separation distance T. The separation distance T is not limited to those for which the evaluation was made. It is expected that the greater the separation distance T, the greater the degree to which the possibility of channeling can be decreased. Accordingly, it is considered that a value greater than 0.45 mm can be employed as the separation distance T. Notably, decreasing the separation distance T is preferred in order to reduce the size of the spark plug. For example, it is preferred that the separation distance T be equal to or shorter than 1 mm.

### B-2. Second Evaluation Test

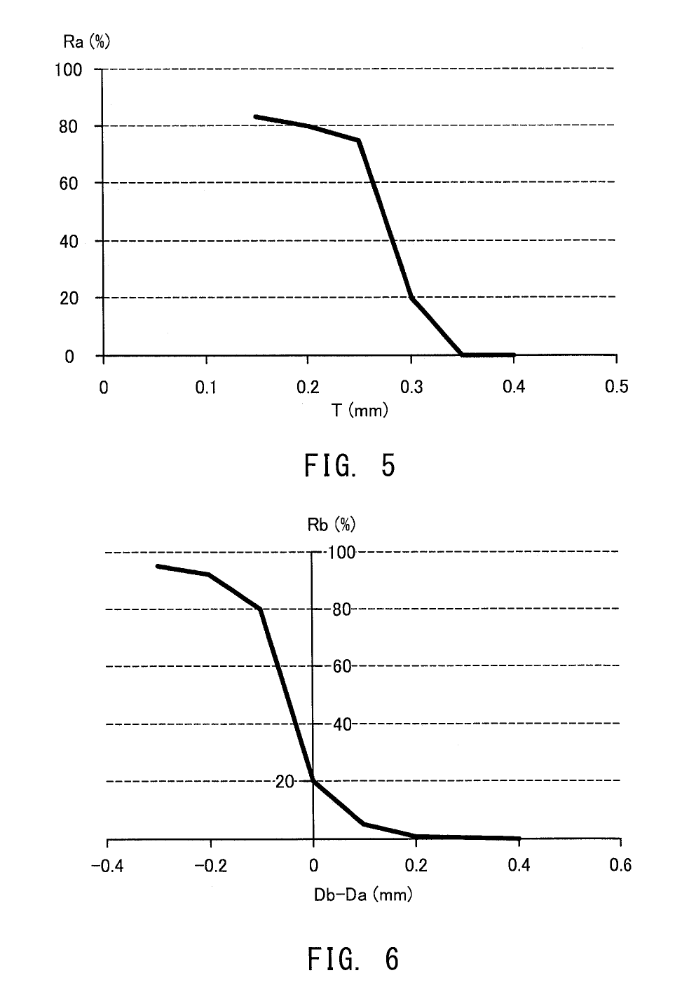

FIG. 5 is a graph showing the results of a second evaluation test. The horizontal axis shows the separation distance T (unit: mm), and the vertical axis shows the channeling ratio Ra (unit: %). The second evaluation test was performed through use of the same ignition system 900 (FIG. 1) as that used in the first evaluation test. Each of samples of the spark plug 100 was disposed in an environment in which the gas flow G1 passes through the gap g as in the first evaluation test. The channeling ratio Ra was calculated as follows. First, paths of 100 times of discharges were photographed through use of a high speed camera. Subsequently, the number of discharges in which the discharge path passed through the surface (in particular, the forward end surface 10h) of the insulator 10 was counted by observing the photographed images. The ratio of the counted number to 100 is the channeling ratio Ra. In this evaluation test, six types of samples having different separation distances T were used. The separation distances T for which evaluation was made were 0.15, 0.2, 0.25, 0.3, 0.35, and 0.4 (mm) (six in total). Notably, the following parameters are common among the six types of samples.

Speed of the gas flow G1: 10 m/sec

Projection length L: 1 mm

Outer diameter Dd of the first tip portion 28 (FIG. 4): 0.7 mm

Output energy of the power supply circuit 600: 100 mJ

Distance difference Db−Da: 0 mm

Reference distance DP: 5 mm

As shown in FIG. 5, when the separation distance T was 0.25 mm or less, the channeling ratio Ra was relatively high (70% or higher). When the separation distance T was 0.3 mm or greater, the channeling ratio Ra was relatively low (20% or lower). As described above, when the separation distance T was 0.3 mm or greater, the channeling ratio Ra was able to be decreased considerably. Also, when the separation distance T was 0.35 mm or greater, the channeling ratio Ra was almost 0%. In view of the forgoing, the separation distance T is preferably set to 0.3 mm or greater, more preferably to 0.35 mm or greater.

### B-3. Third Evaluation Test

FIG. 6 is a graph showing the results of a third evaluation test. The horizontal axis shows the distance difference Db−Da (unit: mm), and the vertical axis shows the spark flying ratio Rb (unit: %). The third evaluation test was performed through use of the same ignition system 900 (FIG. 1) as that used in the first evaluation test. Each of samples of the spark plug 100 was disposed in an environment in which the gas flow G1 passes through the gap g as in the first evaluation test. The spark flying ratio Rb is calculated as follows. First, paths of 100 times of discharges were photographed through use of a high speed camera. Subsequently, the number of discharges in which spark flying to the joint portion 230 was observed was counted by observing the photographed images. The ratio of the counted number to 100 is the spark flying ratio Rb. In this evaluation test, eight types of samples having different distance differences Db-Da were used. The distance differences Db-Da for which evaluation was made were −0.3, −0.2, −0.1, 0, 0.1, 0.2, 0.3, and 0.4 (mm) (eight in total). The adjustment of the distance difference Db−Da was performed by adjusting the second distance Db. The adjustment of the second distance Db was performed by adjusting the length of a portion of the first tip portion 28 located on the rearward direction D1r side in relation to the forward end (specifically, the forward end surface 10h) of the insulator 10; i.e., by adjusting the fourth position U. Notably, the following parameters are common among the eight types of samples.

Speed of the gas flow G1: 10 m/sec

Projection length L: 1 mm

Outer diameter Dd of the first tip portion 28 (FIG. 4): 0.7 mm

Output energy of the power supply circuit 600: 100 mJ

Separation distance T: 0.4 mm

Reference distance DP: 5 mm

As shown in FIG. 6, when the distance difference Db−Da was −0.1 mm or greater, the spark flying ratio Rb was able to be decreased to 80% or less. When the distance difference Db−Da was −0.1 mm or less, the spark flying ratio Rb was relatively high (80% or higher). When the distance difference Db−Da was 0 mm or greater, the spark flying ratio Rb was relatively low (20% or lower). As described above, when the distance difference Db−Da was 0 mm or greater, the spark flying ratio Rb was able to be decreased considerably. Also, when the distance difference Db−Da was 0.3 mm or greater, the spark flying ratio Rb was almost 0%. In view of the forgoing, the distance difference Db−Da is preferably 0 mm or greater, more preferably 0.3 mm or greater. Notably, an arbitrary value which is selected from the distance differences Db-Da for which evaluation was made and is equal to or greater than the above-mentioned preferred lower limit can be employed as the upper limit of the distance difference Db−Da. For example, a value equal to or less than 0.4 mm can be employed as the distance difference Db−Da. It is expected that a good spark flying ratio Rb can be realized even when the distance difference Db−Da is greater than the largest one (i.e., 0.4 mm) of the distance differences Db-Da for which the evaluation was performed. Notably, from the viewpoint of preventing breakage of the first tip portion 28, it is preferred that the length of the first tip portion 28 be short; i.e., the distance difference Db−Da be small. For example, it is preferred that the distance difference Db−Da be 3 mm or less.

### C. Second Embodiment

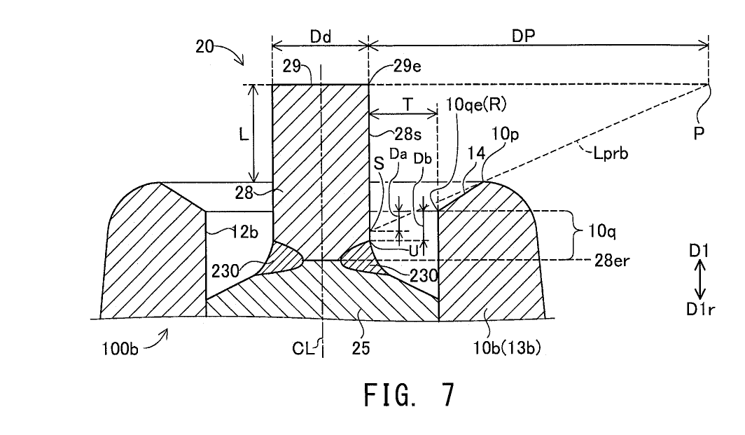

FIG. 7 is a schematic view of a spark plug 100b of a second embodiment. FIG. 7 shows a cross section of a portion of the spark plug 100b which is the same as the portion shown in FIG. 4. The only difference from the first embodiment of FIG. 4 is that an inner-diameter increasing portion 14 whose inner diameter increases gradually toward the forward direction D1 side is formed at the forward end of the insulator 10b (the forward end of the leg portion 13b). The structure of the remaining portion of the spark plug 100b is the same as that of the spark plug 100 of the first embodiment. In the following description, components of the spark plug 100b identical with those of the spark plug 100 are denoted by the same reference numerals, and their description is omitted.

As shown in FIG. 7, in the second embodiment, as a result of formation of the inner-diameter increasing portion 14, the forward end surface 10h of the insulator (FIG. 4) is eliminated. Instead, the insulator 10b has a forward end 10p forming a sharp vertex in the cross section of FIG. 7. In the example of FIG. 7, the forward end 10p of the insulator 10b is the same as the forward end of the inner-diameter increasing portion 14. The projection length L is the length (as measured in a direction parallel to the center axis CL) of a portion of the center electrode 20 located on the forward direction D1 side with respect to the forward end 10p of the insulator 10b.

In the drawing, four positions P, R, S, U and a straight line Lprb are shown. The first position P and the fourth position U are identical with the first position P and the fourth position U of FIG. 4. The straight line Lprb is a straight line which passes through the first position P and is tangent, at one position, to a forward-end-side portion of the contour (contour on the side toward the first position P with respect to the center axis CL) of the insulator 10b. In the embodiment of FIG. 7, the straight line Lprb is a straight line which passes through the first position P and the forward end 10p. The third position S is a position at which the straight line Lprb crosses the surface (surface on the side toward the first position P with respect to the center axis CL) of the center electrode 20. Notably, depending on the inclination of the inner-diameter increasing portion 14 with respect to the center axis CL, there may arise a case where the straight line Lprb passes through the rear end of the inner-diameter increasing portion 14 (the second position R to be described later).

The second position R is determined as follows. In the embodiment of FIG. 7, the diameter of the axial hole 12b changes with the position in the forward direction D1 (in particular, at the inner-diameter increasing portion 14). A part of a portion of the insulator 10b accommodating the first tip portion 28, the part having the smallest inner diameter, will be referred to as a small diameter portion. When the first tip portion 28 and the insulator 10b are projected in a direction orthogonal to the center axis CL, the portion of the insulator 10b accommodating the first tip portion 28 is a portion of the insulator 10b extending toward the forward direction D1 side from the end 28er of the first tip portion 28 on the rearward direction D1r side. Also, in the example of FIG. 7, of the portion of the insulator 10b accommodating the first tip portion 28, a part 10q located on the rearward direction D1r side of the inner-diameter increasing portion 14 corresponds to the small diameter portion (hereinafter referred to as the “small diameter portion 10q).

In the case where discharge occurs on the side surface 28s of the first tip portion 28, the positional relation between the center electrode 20 and the edge 10qe of the inner circumferential surface of the small diameter portion 10q on the forward direction D1 side greatly affect the above-described channeling and spark flying to the joint portion 230. For example, in the case where the edge 10qe is located close to the side surface 28s of the first tip portion 28, discharge which passes through the edge 10qe of the insulator 10 (i.e., channeling) is likely to occur. In contrast, in the case where the edge 10qe is located away from the side surface 28s of the first tip portion 28, channeling is less likely to occur. Accordingly, the edge 10qe of the small diameter portion 10q can be employed as a reference for determining the separation distance T. Also, in the case where the edge 10qe is located close to the joint portion 230, spark flying to the joint portion 230 is likely to occur. Accordingly, the edge 10qe can be employed as a reference for determining the distances Da and Db.

In view of the forgoing, in the case where the inner diameter of the insulator 10b changes with the position in the forward direction D1, the position of the inner edge 10qe, which the edge of the small diameter portion 10q on the forward direction D1 side is employed as the second position R serving as a reference for the distances T, Da, and Db. By disposing the fourth position U on the rearward direction D1r side in relation to the second position R as in the case of the embodiment of FIG. 7, spark flying to the joint portion 230 can be suppressed. Also, it is expected that the above-described preferred range of the separation distance T and the above-described preferred range of the distance difference Db−Da can be applied to the embodiment as shown in FIG. 7. Notably, in the first embodiment shown in FIG. 4, the entirety of the portion 10r of the insulator 10 accommodating the first tip portion 28 corresponds to the small diameter portion. The edge, on the forward direction D1 side, of the inner circumferential surface which defines the axial hole 12 (the second position R in FIG. 4) corresponds to the inner edge.

### C. Modifications

(1) It is expected that the possibility of channeling is greatly influenced by mainly the separation distance T. It is considered that the influences of other parameters (e.g., the distance difference Db−Da, the outer diameter Dd, etc.) are small as compared with the influence of the separation distance T. Accordingly, in the case where the separation distance T falls within the above-described preferred range, it is expected that channeling can be suppressed irrespective of values of other parameters.

Also, it is considered that the possibility of spark flying to the joint portion 230 is greatly influenced by mainly the distance difference Db−Da. It is considered that the influences of other parameters (e.g., the separation distance T, the outer diameter Dd, etc.) are small as compared with the influence of the distance difference Db−Da. Accordingly, in the case where the distance difference Db−Da falls within the above-described preferred range, it is expected that spark flying to the joint portion 230 can be suppressed irrespective of values of other parameters.

Notably, the durability of the spark plug can be enhanced further by configuring the spark plug to satisfy the first condition that the separation distance T falls within the above-described preferred range and the second condition that the distance difference Db−Da falls within the above-described preferred range. However, even when the spark plug satisfies only one of the first and second conditions, the durability of the spark plug can be enhanced, as compared with the case where none of the first and second conditions is satisfied.

(2) In each of the above-described evaluation tests, the projection length L was 1 mm. However, any of various values other than 1 mm can be employed as the projection length L. For example, a value less than 1 mm (e.g., 0.5 mm) may be employed. Also, a value greater than 1 mm (e.g., 2 mm) may be employed. In general, the greater the projection length L, the grater the degree to which the possibility of channeling and the possibility of spark flying to the joint portion 230 can be decreased. Accordingly, it is preferred that the projection length L be 1 mm or greater. Also, it is preferred to decrease the projection length L in order to prevent breakage of the first tip portion 28. For example, it is preferred that a value equal to or less than 5 mm be employed as the projection length L. It is expected that, in either case, the possibility of channeling can be decreased by setting the separation distance T to fall within the above-described preferred range. Also, it is expected that the possibility of spark flying to the joint portion 230 can be decreased by setting the distance difference Db-Da to fall within the above-described preferred range.
(3) In each of the above-described evaluation tests, the outer diameter Dd of the first tip portion 28 was 0.7 mm. However, any of various values other than 0.7 mm can be employed as the outer diameter Dd. For example, a value less than 0.7 mm (e.g., 0.3 mm) may be employed. Also, a value greater than 0.7 mm (e.g., 1 mm) may be employed. In general, the greater the outer diameter Dd of the first tip portion 28, the greater the degree to which expansion of the gap g due to consumption of the tip portion can be prevented. Accordingly, it is preferred that the outer diameter Dd be 0.7 mm or greater. Also, it is preferred to decrease the outer diameter Dd in order to prevent the spark plug from becoming larger. For example, it is preferred that the outer diameter Dd be 4 mm or less. It is expected that, in either case, the possibility of channeling can be decreased by setting the separation distance T to fall within the above-described preferred range. Also, it is expected that the possibility of spark flying to the joint portion 230 can be decreased by setting the distance difference Db−Da to fall within the above-described preferred range.
(4) The structure of the spark plug 100 is not limited to those shown in FIGS. 2, 3, 4, and 7. Any of other various structures can be employed. For example, the joint portion 230 may be formed over the entire interface between the leg portion 25 and the first tip portion 28. Also, the second tip portion 38 of the ground electrode 30 may be omitted.
(5) The configuration of the power supply circuit 600 is not limited to that shown in FIG. 1. Any of other various configurations which can apply high voltage for discharge to the spark plug can be employed. For example, a so-called capacitor discharged ignition may be employed. In either case, the energy output from the power supply circuit 600 to a single plug in each single ignition stroke is determined to match the internal combustion engine. For example, in the evaluation test the results of which is shown in Table 1, evaluation was performed for output energies of 80, 90, 100, 150, and 200 mJ. In each of the cases where these output energies were employed, rank A was able to be realized for the possibility of spark flying to the joint portion, and rank A was able to be realized for the possibility of channeling. Accordingly, it is expected that proper ignition and enhancement of the durability of the spark plug can be realized over a wide range including these output energies. The greater the output energy supplied to a single spark plug in each single ignition stroke, the greater the degree to which the ignition performance under severe conditions (for example, in the case where the speed of the gas flow G1 is high) can be enhanced. For example, the output energy may be 100 mJ or greater, 150 mJ or greater, or 200 mJ or greater. However, from the viewpoint of prolonging the service life of the spark plug, it is preferred that the output energy be small. For example, it is preferred that the output energy be 600 mJ or less. Also, the upper limit of the output energy may be selected from the output energies for which evaluation was made. For example, the output energy may be 200 mJ or less, or 150 mJ or less. Notably, the controller 500 may change the output energy of the power supply circuit 600 in accordance with the operating conditions of the internal combustion engine 700.

Although the present invention has been described on the basis of embodiments and modifications thereof, the embodiments of the present invention are provided for facilitating an understanding of the present invention and do not limit the scope of the present invention. The present invention may be changed and improved without departing from the scope of the present invention, and encompasses equivalents thereof.

### DESCRIPTION OF REFERENCE NUMERALS AND SYMBOLS

5 . . . gasket, 6 . . . first rear-end-side packing, 7 . . . second rear-end-side packing, 8 . . . forward-end-side packing, 9 . . . talc, 10, 10b . . . insulator (ceramic insulator), 10h . . . forward end surface, 10p . . . forward end, 11 . . . second outer-diameter decreasing portion, 12 . . . through hole (axial hole), 12s . . . inner circumferential surface, 13 . . . leg portion, 14 . . . inner-diameter increasing portion, 10r, 10q . . . small diameter portion, 10re, 10qe . . . inner edge, 15 . . . first outer-diameter decreasing portion, 16 . . . inner-diameter decreasing portion, 17 . . . forward-end-side trunk portion, 18 . . . rear-end-side trunk portion, 19 . . . flange portion, 20 . . . center electrode, 21 . . . outer layer, 22 . . . core, 23 . . . head portion, 24 . . . flange portion, 25 . . . leg portion, 27 . . . shaft portion, 28 . . . first tip portion, 28s . . . side surface, 28er . . . end, 29 . . . forward end surface, 29e . . . edge, 30 . . . ground electrode, 31 . . . distal end portion, 35 . . . base member, 36 . . . core, 37 . . . shaft portion, 38 . . . second tip portion, 39 . . . rear end surface, 40 . . . metallic terminal, 50 . . . metallic shell, 51 . . . tool engagement portion, 52 . . . screw portion, 53 . . . crimp portion, 54 . . . seat portion, 55 . . . trunk portion, 56 . . . inner-diameter decreasing portion, 57 . . . forward end, 58 . . . deformable portion, 59 . . . through hole, 60 . . . first seal portion, 70 . . . resistor, 80 . . . second seal portion, 100, 100b . . . spark plug, 230 . . . joint portion, 500 . . . controller, 510 . . . battery, 600 . . . power supply circuit, 620 . . . primary coil, 630 . . . secondary coil, 640 . . . core, 650 . . . igniter, 700 . . . internal combustion engine, 900 . . . ignition system, G1 . . . gas flow, CL . . . center axis (axial line), T separation distance, P . . . first position, R . . . second position, S . . . third position, U . . . fourth position, g . . . gap, L projection length, Lpr, Lprb . . . straight line

1. A spark plug comprising:
a tubular insulator having an axial hole extending therethrough along an axial line;
a center electrode disposed at an end of the axial hole on a forward end side; and
a ground electrode forming a gap between the ground electrode and a forward end portion of the center electrode, wherein
the center electrode includes a shaft portion, a tip portion joined to a forward end portion of the shaft portion, and a joint portion joining the shaft portion and the tip portion together;
an end of the joint portion on the forward end side is located on a rear end side in the direction of the axial line in relation to an inner edge of the insulator, which is a forward-end-side edge of an inner circumferential surface of a small diameter portion of the insulator, the small diameter portion being a part of an accommodation portion of the insulator that accommodates the tip portion, and having the smallest inner diameter therein; and
a distance between the inner edge and a surface of the center electrode is 0.3 mm or greater.

2. A spark plug according to claim 1, wherein the distance between the inner edge and the surface of the center electrode is 0.35 mm or greater.

3. A spark plug comprising:
a tubular insulator having an axial hole extending therethrough along an axial line;
a center electrode disposed at an end of the axial hole on a forward end side; and
a rod-shaped ground electrode forming a gap between the ground electrode and a forward end portion of the center electrode, wherein
the center electrode includes a shaft portion, a tip portion joined to a forward end portion of the shaft portion, and a joint portion joining the shaft portion and the tip portion together;
an end of the joint portion on the forward end side is located on a rear end side in the direction of the axial line in relation to an inner edge of the insulator, which is a forward-end-side edge of an inner circumferential surface of a small diameter portion of the insulator, the small diameter portion being a part of an accommodation portion of the insulator that accommodates the tip portion, and having the smallest inner diameter therein; and
when a position separated from an edge of an end surface of the center electrode on the forward end side by 5 mm in a direction orthogonal to the axial line is defined as a first position, a position on the inner edge of the insulator is defined as a second position, a position of intersection between the surface of the center electrode and a straight line is defined as a third position, as viewed on a cross section including the axial line, the straight line passing through the first position and being tangent, at one position, to a forward-end-side portion of a contour of the insulator on a side toward the first position with respect to the center axis, a distance between the third position and the second position in an axial direction is defined as a first distance, and a distance between the second position and the end of the joint portion on the forward end side in the axial direction is defined as a second distance,
a difference obtained by subtracting the first distance from the second distance is 0 mm or greater.

4. A spark plug according to claim 3, wherein the difference is 0.3 mm or grater.

5. A spark plug according to claim 1, wherein a length of the forward end portion of the center electrode in the axial direction is 1 mm or greater.

6. A spark plug according to claim 1, wherein the tip portion has a substantially circular columnar shape extending along the axial line, and the tip portion has an outer diameter of 0.7 mm or greater.

7. An ignition system comprising:
a spark plug according to claim 1; and
a power supply circuit that supplies electrical energy to the gap of the spark plug, wherein
spark discharge is generated at the gap as a result of supply of electrical energy to the gap from the power supply circuit, and
the power supply circuit outputs an energy of 100 mJ or greater in each single ignition stroke.
